(19) United States
(12) Patent Application Publication
(10) Pub. No.: US 2023/0418551 A1
(43) Pub. Date: Dec. 28, 2023

(54) AUDIO DEVICE, CONTROL METHOD FOR AUDIO DEVICE, AND PROGRAM

(71) Applicant: AlphaTheta Corporation, Yokohama-shi, Kanagawa (JP)

(72) Inventors: Takahisa Ohkuma, Yokohama-shi, Kanagawa (JP); Nao Takagi, Yokohama-shi, Kanagawa (JP); Ayumi Satoh, Yokohama-shi, Kanagawa (JP)

(21) Appl. No.: 18/252,109

(22) PCT Filed: Nov. 10, 2020
(86) PCT No.: PCT/JP2020/041918

§ 371 Date: May 8, 2023

(51) Int. Cl. G06F 3/16; G10H 1/00

(52) U.S. Cl. CPC G06F 3/165; G10H 1/0008; G10H 1/0091; G10H 2210/076

(57) ABSTRACT

Provided is an audio device that plays back music data. The audio device includes a first playback controller that performs, when a user performs an ON operation during playback of first music, application of a first effect to the first music, the first effect being set in association with the first music, and performs, when the user performs an OFF operation after the application of the first effect, application of a second effect to the first music or playback of a sampling sound, the second effect being different from the first effect.

### TECHNICAL FIELD

The present invention relates to an audio device, a method of controlling an audio device, and a program.

### BACKGROUND ART

Conventionally, a DJ device such as a DJ controller has included multiple decks, and has performed switching from a piece of music being played back to another piece of music by switching audio output between the decks while playing back the pieces of music by the respective decks (for example, see Patent Literature 1).

Upon performing switching between pieces of music in the DJ device, a cross fader provided on the DJ device is used. The cross fader adjusts sound volumes of the multiple decks. An operation element of the cross fader is moved from one end to the other, whereby the volume of the sound to be outputted from the deck performing playback and the volume of the sound to be outputted from the deck to which the switching is to be performed are gradually changed. Thus, the switching between pieces of music is performed. Further, application of various effects in accordance with changes in volumes of sounds to be outputted from the respective decks makes it possible to perform switching between pieces of music with higher performance effect.

### CITATION LIST

### Patent Literature(s)

Patent Literature 1: Japanese Patent No. 4781491

### SUMMARY OF THE INVENTION

### Problem(s) to be Solved by the Invention

Upon performing switching between pieces of music described above, first, selection of pieces of music to be played before and after the switching is important. Specifically, it is important that a difference in tempo between the pieces of music before and after the switching be small, and that there be no uncomfortableness in terms of a genre and a music tone between the pieces of music before and after the switching. Such music selection necessitates musical knowledge and experience.

Further, the switching between the pieces of music necessitates an accurate and complicated user operation. Specifically, it is necessary to accurately perform the following operations in accordance with rhythms of the pieces of music, for example, an operation of synchronizing tempos of the pieces of music before and after the switching, an operation of applying various effects to the music being played back, a cueing operation of selecting a playback-start position of the music to be played back next, and the above-described switching operation.

In addition, the application of effects also necessitates musical knowledge and experiences, as well as the accurate and complicated user operation.

It is therefore an object of the invention to provide an audio device, a method of controlling an audio device, and a program which make it possible even for a user having little musical knowledge or experience to perform switching between pieces of music with high performance effect by a simple operation.

### Means for Solving the Problem(s)

[1] An audio device configured to play back music data, the audio device including a first playback controller configured to perform, in a case where a user performs an ON operation during playback of first music, application of a first effect to the first music, the first effect being set in association with the first music; and configured to perform, in a case where the user performs an OFF operation after the application of the first effect, application of a second effect to the first music or playback of a sampling sound, the second effect being different from the first effect.
[2] The audio device according to [1], in which the first playback controller is configured to play back an effect sound related to the first effect or the second effect in synchronization with a beat position of the first music.
[3] The audio device according to [1] or [2], in which, in a case where the OFF operation is performed, the first playback controller is configured to perform the playback of the sampling sound after the application of the second effect to the first music, or to perform the application of the second effect to the first music after the playback of the sampling sound.
[4] The audio device according to any of [1] to [3], further including a storage unit in which setting information is stored, the setting information including a combination of the first effect, and the second effect or the sampling sound.
[5] The audio device according to any of [1] to [4], in which the first effect or the second effect includes multiple effects.
[6] The audio device according to any of [1] to [5], further including a second playback controller configured to perform playback of second music after the application of the second effect or after the playback of the sampling sound, the second music being different from the first music.
[7] The audio device according to any of [1] to [6], further including: one operation element configured to receive a rotating operation and a switching operation; and a parameter setting unit configured to set a parameter related to the first effect in response to the rotating operation, in which the ON operation includes the switching operation.
[8] A method of controlling an audio device configured to play back music data, the method including: performing, in a case where a user performs an ON operation during playback of first music, application of a first effect to the first music, the first effect being set in association with the first music; and performing, in a case where the user performs an OFF operation after the application of the first effect, application of a second effect to the first music or playback of a sampling sound, the second effect being different from the first effect.
[9] A program causing a computer to operate as an audio device, the audio device including a first playback controller configured to perform, in a case where a user performs an ON operation during playback of first music, application of a first effect to the first music, the first effect being set in association with the first music; and configured to perform, in a case where the user performs an OFF operation after the application of the first effect, application of a second effect to the first music or playback of a sampling sound, the second effect being different from the first effect.

According to the above-described configurations, when the user performs the ON operation during the playback of the first music, the first effect which is set in association with the first music is applied to the first music, and, when the user performs the OFF operation after the application of the first effect, the second effect which is different from the first effect is applied to the first music or the sampling sound is played back. This makes it possible even for a user having little musical knowledge or experience to perform switching between pieces of music with high performance effect by a simple operation.

### BRIEF DESCRIPTION OF DRAWING(S)

FIG. 1 is a schematic diagram illustrating an audio device according to one exemplary embodiment of the invention.

FIG. 2 is a block diagram illustrating a schematic functional configuration of an audio device according to one exemplary embodiment of the invention.

FIG. 3 is a schematic diagram illustrating a mixing process according to one exemplary embodiment of the invention.

FIG. 4 is a diagram illustrating an example of setting information stored in an effect storage unit.

FIG. 5 is a flowchart illustrating a playback control method according to one exemplary embodiment of the invention.

### DESCRIPTION OF EMBODIMENT(S)

The following describes exemplary embodiments of the invention.

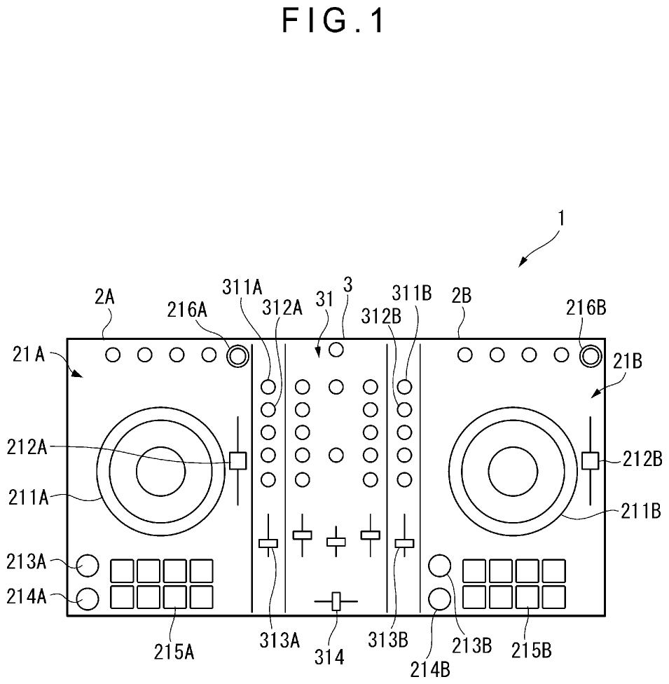

FIG. 1 is a schematic diagram illustrating an audio device according to an exemplary embodiment.

An audio device 1 according to the present exemplary embodiment is a DJ system in which two players, players 2A and 2B, and a mixer 3 are integrated. The players 2A and 2B play back music. The mixer 3 controls the players 2A and 2B. Specifically, the audio device 1 operates as an audio playback device and an audio playback control device by being operated by a user. The audio device 1 plays back music, and applies various effects to music being played back.

Examples of the effects include: an effect that plays back an effect sound based on application, to music, of a so-called effect such as delay, echo, reverb, or loop; and an effect that plays back a sound based on processing of an original sound. Examples of the effect that plays back the sound obtained by processing the original sound include: an effect which is called a pitch, for example, that plays back a sound obtained by altering a pitch of the original sound; and an effect which is called a filter, for example, that plays back a sound obtained by filtering a particular frequency band of the original sound.

As illustrated in FIG. 1, the audio device 1 includes operation units 21A and 21B that are respectively provided on the players 2A and 2B, and an operation unit 31 provided on the mixer 3.

The operation unit 21A receives a user operation on the player 2A, and the operation unit 21B receives a user operation on the player 2B. The operation unit 31 receives a user operation on the mixer 3.

The operation unit 21A includes a jog wheel 211A, a tempo slider 212A, a cue button 213A, a play/pause button 214A, a performance pad 215A, and a mix switch 216A.

The jog wheel 211A operates as a rotary operation element and is a wheel to be used in setting a playback direction and a playback speed of music being played back in the player 2A The tempo slider 212A is a lever that adjusts the playback speed of the music being played back in the player 2A.

The cue button 213A is a button to be pressed in setting a predetermined position in music as a cue point.

The play/pause button 214A is a button to be pressed in starting or stopping playback of music in the player 2A.

The performance pad 215A is a versatile operation element to which various functions related to playback control are allocatable.

The mix switch 216A is an operation element that is able to receive a rotating operation and an on/off switching operation performed by the user, and is used for a setting related to a mixing process that achieves switching between pieces of music with high performance effect by a simple operation. Details of the mixing process will be described later. The mix switch 216A may be a dedicated operation element related to the mixing process as illustrated in FIG. 1, or an existing operation element may be used as the mix switch 216A. In a case of using the existing operation element, for example, multiple operation elements including an operation element that is able to receive the rotating operation and an operation element that is able to receive the on/off switching operation may be used.

As with the operation unit 21A, the operation unit 21B includes a jog wheel 211B, a tempo slider 212B, a cue button 213B, a play/pause button 214B, a performance pad 215B, and a mix switch 216B,

When the user performs an operation on the operation unit 21A of the player 2A, for example, the audio device 1 plays back music loaded in the player 2A, and applies an effect to the music being played back. The same applies to the player 2B.

The mixer 3 executes switching of music playback between the players 2A and 2B, adjustment of a volume of each channel, and playback to which an effect is applied, in response to user operations.

The operation unit 31 of the mixer 3 includes effect selection knobs 311A and 311B, effect amount adjustment knobs 312A and 312B, channel faders 313A and 313B, and a cross fader 314.

The effect selection knobs 311A and 311B are knobs to be used in selecting effects to be applied to pieces of music being played back in the players 2A and 2B, respectively.

The effect amount adjustment knobs 312A and 312B are knobs to be used in adjusting parameters such as depths or magnitudes of effects to be applied to pieces of music being played back in the players 2A and 2B, respectively.

The channel faders 313A and 313B are levers to be used in adjusting output volume levels of pieces of music being played back in the players 2A and 2B, respectively.

The cross fader 314 is a lever to be used in switching output volume levels of pieces of music to be outputted from the players 2A and 2B.

The operation units 21A and 21B and the operation unit 31 may each further include, for example, a touch panel that detects a contact position where the user touches, in addition to the above-described configurations.

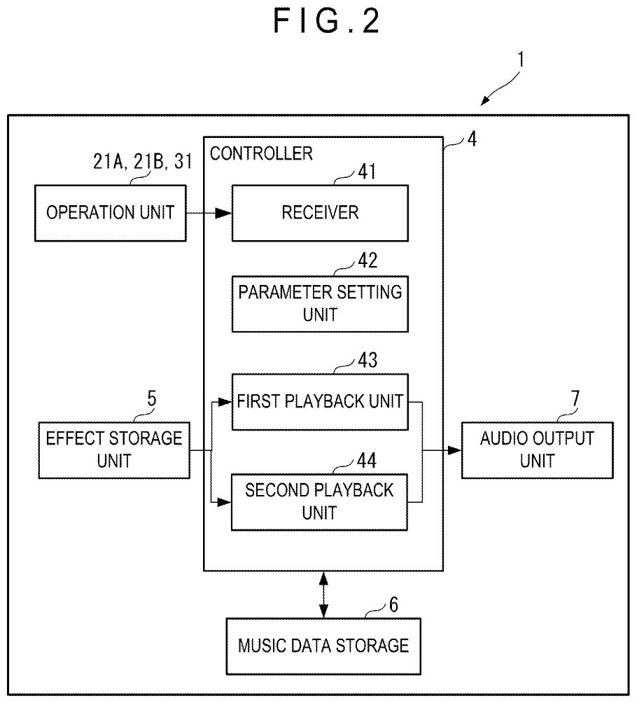

FIG. 2 is a block diagram illustrating a schematic functional configuration of an audio device according to an exemplary embodiment.

As illustrated in FIG. 2, in addition to the above-described components, the audio device 1 includes a controller 4, an effect storage unit, a music data storage 6, and an audio output unit 7. Respective functions of the above-described components are achieved by, for example, a processor operating in accordance with a program, in an audio device having a hardware configuration of a computer. Hereinafter, the respective functions of the components will be further described.

The controller 4 is implemented in the audio device 1 by, for example, a communication interface, a processor such as a central processing unit (CPU), and a memory to be a work area, and controls operation of the audio device 1. The controller 4 includes a receiver 41, a parameter setting unit 42, a first playback unit 43, and a second playback unit 44 which are achievable by a processor operating in accordance with a program stored in a memory or received via a communication interface.

The receiver 41 detects a user operation on each of the operation units 21A, 21B and 31, and receives the user operation. Thereafter, the receiver 41 supplies information indicating content of the user operation to each component in the controller 4.

The parameter setting unit 42 sets a parameter related to an effect to be applied to the first playback unit 43 or to the second playback unit 44 upon performing the mixing process.

The first playback unit 43 plays back music in the player 2A and outputs an audio signal to the audio output unit 7. The second playback unit 44 plays back music in the player 2B and outputs an audio signal to the audio output unit 7. Further, the first playback unit 43 applies an effect to the music being played back in the player 2A, and the second playback unit 44 applies an effect to the music being played back in the player 2B.

The effect storage unit 5 stores setting information including a combination of various effects and a sampling sound for the mixing process.

The music data storage 6 is configured to store music data by means of, for example, a hard disk drive (HDD) or a flash memory. The music data storage 6 stores music data of multiple pieces of music in a predetermined format such as an MP3 format. In addition to audio information, the music data includes, as tag information: information of BPM, an artwork, a title, an artist name, an album title, a key, the number of times played by DJ, and a genre, of the music. The music data to be stored in the music data storage 6 is associated with a time stamp which is information of a playback position.

The audio device 1 may include a communication interface. With that configuration, music data stored in, for example, an external storage device and a computer may be acquired, via the unillustrated communication interface and then be stored in the music data storage 6. In that configuration, the audio device 1 does not include the music data storage 6, and the external storage device operates as the music data storage 6.

The audio output unit 7 includes, for example, a speaker and a headphone terminal, and outputs the respective audio signals of the music played back by the first playback unit 43 and the music played back by the second playback unit 44 as the audio information.

A description is given of an operation of the controller 4 during the mixing process in the audio device 1. As described above, the mixing process is a process of performing switching between pieces of music with high performance effect by a simple operation.

Conventionally, switching between pieces of music with high performance effect has been performed by adjusting volumes of pieces of music to be played back by the players 2A and 2B with use of the channel faders 323A and 323B and the cross fader 324, and applying various effects to the pieces of music.

However, this necessitates musical knowledge and experience, and also necessitates an accurate and complicated user operation. According to the mixing process of the present exemplary embodiment, the switching between pieces of music with high performance effect is performed by a simple operation with use of the mix switch 216A of the operation unit 21A or the mix switch 216B of the operation unit 21B.

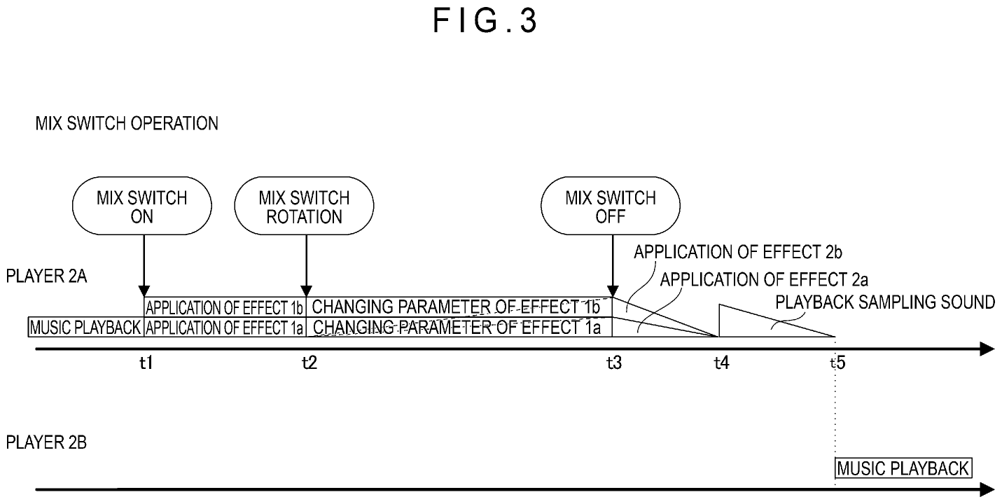

FIG. 3 is a schematic diagram illustrating a mixing process according to an exemplary embodiment. Hereinafter, switching from music played back by the player 2A to music played back by the player 2B will be described as an example.

As illustrated in FIG. 3, the controller 4 receives an ON operation, a rotating operation, and an OFF operation performed on the mix switch 216A by the user. In response to the user operations, the controller 4 applies a first effect to a first music being played back in the player 2A, applies a second effect that is different from the first effect to the first music being played back in the player 2A, stops playback of the first music and plays back a sampling sound, and plays back a second music that is different from the second music.

The first effect is an effect which is suitable for the first half of a section before the switching between pieces of music, and a parameter related to the first effect is changeable by a user operation on the mix switch 216A. The second effect is an effect which is suitable for the latter half of the section before the switching between pieces of music.

The first effect and the second effect may each include multiple effects. In the following, a case in which the first effect and the second effect each include two effects will be described as an example. The two effects included in the first effect are referred to as effects 1a and 1b, and the two effects included in the second effect are referred to as effects 2a and 2b.

The sampling sound is a sound effect that is played back immediately before the switching between pieces of music to reduce uncomfortableness upon the switching between pieces of music, making it possible to enhance performance effect. Examples of the sampling sound include a sound of a brass musical instrument such as a horn, and a sound of a percussion musical instrument such as a drum. The sampling sound preferably has a predetermined length. The effect storage unit 5 or the music data storage 6 stores in advance multiple sampling sounds. Note that a portion of music data stored in the music data storage 6 may be used as the sampling sound.

The effect storage unit 5 stores setting information including a combination of the first effect, the second effect, and the sampling sound described above.

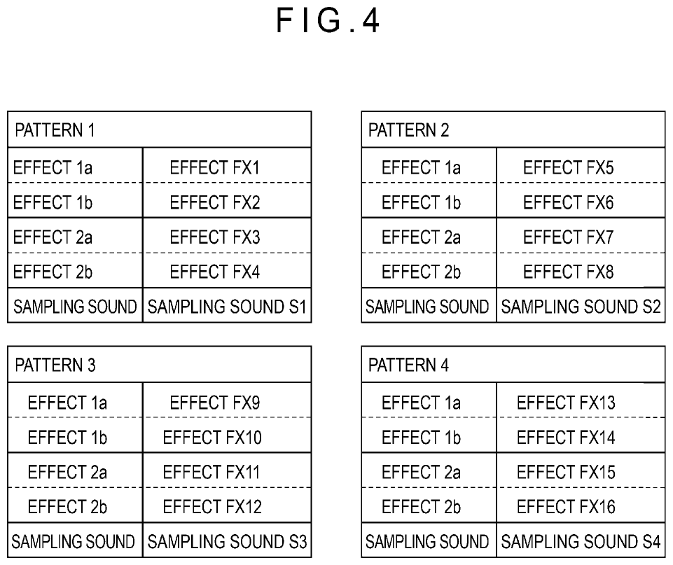

FIG. 4 is a diagram illustrating an example of the setting information stored in the effect storage unit 5. As illustrated in patterns 1 to 4 in FIG. 4, the setting information includes a combination of the effects 1a and 1b included in the first effect, the effects 2a and 2b included in the second effect, and the sampling sound. In the example illustrated in FIG. 4, effects FX1 to FX16 which are different from each other are each set as the corresponding one of the effects 1a and 1b and effects 2a and 2b, and sampling sounds S1 to S4 are each set as the sampling sound.

Although FIG. 4 illustrates the example in which the effect storage unit 5 stores four pieces of setting information of the patterns 1 to 4, the number of pieces of setting information to be stored in the effect storage unit 5 may be any as long as the number is one or more.

Further, the setting information may be set by the user, or a preferable combination may be stored in advance. In addition, the user may change some or all of the preferable combination that is stored in advance, and the changed combination may be stored.

Further, in order to select one piece of setting information from the multiple pieces of setting information stored in the effect storage unit 5, dedicated operation elements may be provided in the operation units 21A and 21B, or an existing operation element may be used.

Referring back to FIG. 3, when the ON operation is performed on the mix switch 216A at a time t1 during the playback of the music in the player 2A, the controller 4 applies the first effect to the music being played back in the player 2A.

The controller 4 reads out the setting information from the effect storage unit 5, and the first playback unit 43 applies, to the first music, the effects 1a and 1b that are set as the first effect of the read-out setting information. In this case, the first playback unit 43 may play back an effect sound related to the first effect in synchronization with a beat position of the first music. The beat position is obtainable by analyzing first music data in advance based on an existing music analysis technique. Synchronizing the effect sound with the beat position makes it possible to further enhance performance effect of the first effect.

Further, upon applying the first effect in response to the ON operation on the mix switch 216A, the parameter of the effect may be a fixed parameter or a parameter variable in accordance with a preset change.

Upon receiving the user operation of rotating the mix switch 216A at a time t2, the controller 4 changes a parameter related to the first effect in response to the rotating operation.

In response to the rotating operation received by the receiver 41, the parameter setting unit 42 sets respective parameters of the effects 1a and 1b that serve as the first effect, and the first playback unit 43 applies the set first effect to the first music. For example, in a case where the rotating operation is an operation performed in a direction to increase an effect amount, the parameter setting unit 42 changes the respective parameters of the effects 1a and 1b that are set as the first effect in response to the rotating operation, and the first playback unit 43 applies the first effect to the first music based on the changed parameters. As a result, the effects 1a and 1b are changed in conjunction with each other. Here, as with the above-described case, the first playback unit 43 may play back the effect sound related to the first effect in synchronization with a beat position of the first music.

When the OFF operation is performed on the mix switch 216A at a time t3, the controller 4 applies the second effect to the first music being played back in the player 2A.

The controller 4 applies, to the first music, the effects 2a and 2b that are set as the second effect of the setting information read out from the effect storage unit 5. Here, as with the above-described case, the first playback unit 43 may play back an effect sound related to the second effect in synchronization with a beat position of the first music. Upon applying the second effect in response to the OFF operation on the mix switch 216A, the parameter of the effect may be a fixed parameter or a parameter variable in accordance with a preset change.

At a time t4, the controller 4 stops the playback of the first music in the player 2A and plays back the sampling sound. The stopping of the playback of the first music and the playing back of the sampling sound are not performed in response to the user operation, but are performed at a timing at which a predetermined time period (t4-t3 in FIG. 4) has elapsed since the OFF operation on the mix switch 216A is received. The predetermined time period may be set in advance, or may be set by the user.

When the predetermined time period has elapsed from the performance of the OFF operation on the mix switch 216A, the first playback unit 43 stops the playback of the first music and plays back the sampling sound set in the setting information read out from the effect storage unit 5.

At a time t5, the controller 4 starts playing back music in the player 2B. The playback of the second music is not performed in response to the user operation, but is performed at a timing at which a predetermined time period (t5-t3 in FIG. 4) has elapsed from the performance of the OFF operation on the mix switch 216A. The predetermined time period is a sum of the time period during which the second effect is applied and a length of the sampling sound.

The second playback unit 44 plays back the second music when the predetermined time period has elapsed from the performance of the OFF operation on the mix switch 216A. Here, it is assumed that a playback-start position of the second music is designated in advance by the user operation with use of, for example, the cue button 213B and the play/pause button 214B.

As described above, upon performing switching from the music played back by the player 2A to the music played back by the player 2B: when the user performs the ON operation on the mix switch 216A, the application of the first effect to the first music being played back in the player 2A is started; when the user performs the rotating operation on the mix switch 216A, the parameter of the first effect is changed; and when the user performs the OFF operation on the mix switch 216A, the second effect is applied to the first music, following which the playback of the first music is stopped, and in addition, the sampling sound is played back, following which the playback of the second music in the player 2B is started. That is, the user only performs a simple operation on the mix switch 216 which is a single operation element, which allows the audio device 1 to perform a preferable series of processes for the switching between pieces of music, and consequently allows the switching between pieces of music with high performance effect.

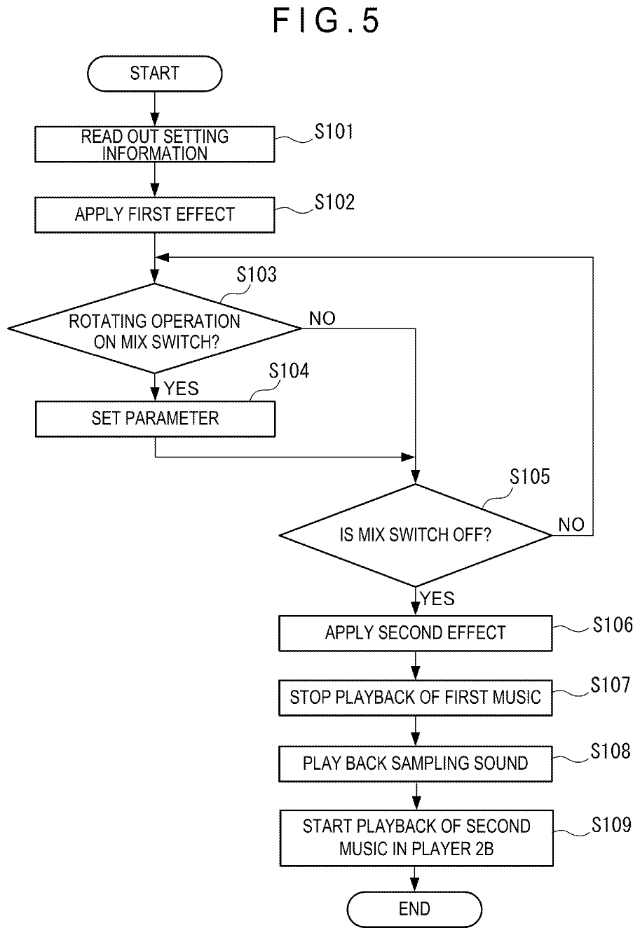

Next, referring to a flowchart in FIG. 5, a method of controlling an audio device according to an exemplary embodiment of the invention will be described.

FIG. 5 illustrates the flowchart of a process which is to be started when the receiver 41 receives the ON operation on the mix switch 216. Hereinafter, a case will be described as an example where the ON operation on the mix switch 216A is received during the playback of the first music in the player 2A.

First, the first playback unit 43 reads out the setting information from the effect storage unit 5 (Step S101). The first playback unit 43 applies the first effect to the music being played back in accordance with the read-out setting information (Step S102).

When the receiver 41 receives the user operation of rotating the mix switch 216 (Step S103: YES), the parameter setting unit 42 sets the parameter of the first effect to be applied to the music being played back in response to the rotating operation (Step S104).

When the receiver 41 does not receive the user operation of rotating the mix switch 216 even after the elapse of a predetermined time period (Step S103: NO), the controller 4 determines whether the OFF operation on the mix switch 216A is received (Step S105). When the controller 4 determines that the receiver 41 does not receive the OFF operation on the mix switch 216 even after the elapse of a predetermined time period (Step S105: NO), the controller 4 returns the process to Step S103.

When the controller 4 determines that the receiver 41 has received the OFF operation on the mix switch 216 (Step S105: YES), the first playback unit 43 applies the second effect to the music being played back in accordance with the setting information read out in Step S101 (Step S106), and stops playing back the first music after the elapse of a predetermined time period (Step S107).

The first playback unit 43 plays back the sampling sound in accordance with the setting information read out in Step S101 (Step S108), and the second playback unit 44 starts the playback of the second music in the player 28 (Step S109).

Note that the switching from the music played back by the player 2A to the music played back by the player 2B has been described as an example in FIGS. 3 to 5; however, a similar process is performed for switching from the music played back by the player 2B to the music played back by the player 2A, That is, when the ON operation on the mix switch 216B is received during playback of the first music in the player 2B, the application of the first effect to the first music being played back in the player 28 is started: when the user performs the rotating operation on the mix switch 2168, the parameter of the first effect is changed; and when the user performs the OFF operation on the mix switch 216B, the second effect is applied to the first music, following which the playback of the first music is stopped, and in addition, the sampling sound is played back, following which playback of the second music in the player 2A is started.

According to the exemplary embodiments of the invention described above, when the user performs the ON operation during the playback of the first music, the first effect that is set in association with the first music is applied to the first music; and when the user performs the OFF operation after the application of the first effect, the second effect that is different from the first effect is applied to the first music, and the sampling sound is played back. Accordingly, even if the difference in tempo between the pieces of music before and after the switching is large, or even if the pieces of music before and after the switching are different in a genre and a music tone, it is possible to reduce uncomfortableness and to perform switching between pieces of music with high performance effect. This eliminates the need for musical knowledge and musical experience in selecting pieces of music before and after the switching. Further, the switching between pieces of music with high performance effect is achievable without the need for the accurate and complicated user operation.

Furthermore, according to the exemplary embodiments of the invention described above, the first effect or the second effect includes multiple effects. This makes it possible to play back music to which multiple effects are applied by a simple operation, without the need for an operation of adjusting the effects upon the switching between pieces of music.

Note that the user operations described in the above exemplary embodiments are merely examples, and are not limited thereto. For example, in response to a user operation of turning on the mix switch 216A or 216B, a series of processes may be performed including the playback of the first music to which the first effect is applied, the application of the second effect that is different from the first effect, and the playback of the sampling sound. In this case, it is possible to achieve effects similar to those of the above-described exemplary embodiments by only performing a single user operation on the mix switch 216A or 216B.

Further, only one of the application of the second effect and the playback of the sampling sound described in the above exemplary embodiments may be performed. Furthermore, the example has been described above in which the playback of the sampling sound is performed after the application of the second effect; however, the application of the second effect may be performed after the playback of the sampling sound, or the application of the second effect and the playback of the sampling sound may be simultaneously performed in part or entirely. Moreover, the user may set an execution order and timings for the application of the second effect and the playback of the sampling sound. In any of these cases, versatility and flexibility of performance effect can be enhanced.

Further, the timing at which the playback of the first music is stopped described in the above exemplary embodiments is merely an example, and is not limited thereto. For example, the playback of the first music may be stopped after completion of the playback of the sampling sound.

Further, the playback of the second music after the switching described in the above exemplary embodiments may start in response to the user operation. In this case, upon performing switching between pieces of music, a series of processes up to the starting of the playback of the second music may be achieved by a simple operation.

Further, the audio device having the above-described functions is not limited to the DJ system described above in the exemplary embodiments, and may be, for example, a mixer or a DJ controller having a mixer function. In the examples described above, a two-channel audio device having two players 2A and 2B has been described; however, a four-channel audio device, for example, is also able to achieve a similar function. Further, the invention is not limited to the DJ device, and is also applicable to an audio device such as a common mixer or an electronic musical instrument.

Preferred exemplary embodiments of the invention have been described above in detail with reference to the accompanying drawings, but the invention is not limited thereto. It is apparent that a person having ordinary skill in the art of the invention can arrive at various alterations and modifications within the scope of the technical idea recited in the appended claims, and it is understood that such alterations and modifications naturally fall within the technical scope of the invention.

### EXPLANATION OF CODE(S)

1 . . . audio device, 2A, 2B . . . player, 3 . . . mixer, 4 . . . controller, 5 . . . effect storage unit, 6 . . . music data storage, 7 . . . audio output unit, 21A, 21B, 31 . . . operation unit, 41 . . . receiver, 42 . . . parameter setting unit, 43 . . . first playback unit, 44 . . . second playback unit, 211A, 211B . . . jog wheel, 212A, 212B . . . tempo slider, 213A, 213B . . . cue button, 214A, 214B . . . play/pause button, 215A, 215B . . . performance pad, 216A, 216B mix switch, 311A, 311B . . . effect selection knob, 312A, 312B . . . effect amount adjustment knob, 313A, 313B . . . channel fader, 314 . . . cross fader.

1. An audio device configured to play back music data, the audio device comprising a first playback controller configured to perform, in a case where a user performs an ON operation during playback of first music, application of a first effect to the first music, the first effect being set in association with the first music; and configured to perform, in a case where the user performs an OFF operation after the application of the first effect, application of a second effect to the first music or playback of a sampling sound, the second effect being different from the first effect.

2. The audio device according to claim 1, wherein the first playback controller is configured to play back an effect sound related to the first effect or the second effect in synchronization with a beat position of the first music.

3. The audio device according to claim 1, wherein, in a case where the OFF operation is performed, the first playback controller is configured to perform the playback of the sampling sound after the application of the second effect to the first music, or to perform the application of the second effect to the first music after the playback of the sampling sound.

4. The audio device according to claim 1, further comprising a storage unit in which setting information is stored, the setting information comprising a combination of the first effect, and the second effect or the sampling sound.

5. The audio device according to claim 1, wherein the first effect or the second effect comprises multiple effects.

6. The audio device according to claim 1, further comprising a second playback controller configured to perform playback of second music after the application of the second effect or after the playback of the sampling sound, the second music being different from the first music.

7. The audio device according to claim 1, further comprising:
one operation element configured to receive a rotating operation and a switching operation; and
a parameter setting unit configured to set a parameter related to the first effect in response to the rotating operation, wherein
the ON operation comprises the switching operation.

8. A method of controlling an audio device configured to play back music data, the method comprising:
performing, in a case where a user performs an ON operation during playback of first music, application of a first effect to the first music, the first effect being set in association with the first music; and
performing, in a case where the user performs an OFF operation after the application of the first effect, application of a second effect to the first music or playback of a sampling sound, the second effect being different from the first effect.

9. A non-transitory computer-readable storage medium storing a program causing a computer to operate as an audio device, the audio device comprising a first playback controller configured to perform, in a case where a user performs an ON operation during playback of first music, application of a first effect to the first music, the first effect being set in association with the first music; and configured to perform, in a case where the user performs an OFF operation after the application of the first effect, application of a second effect to the first music or playback of a sampling sound, the second effect being different from the first effect.
